(19) United States
(12) Patent Application Publication
(10) Pub. No.: US 2018/0172084 A1
(43) Pub. Date: Jun. 21, 2018

(54) ELECTRONIC CLUTCH ACTUATOR

(71) Applicant: BorgWarner Inc., Auburn Hills, MI (US)

(72) Inventors: Xinqian XIANG, Troy, MI (US); Michael CAMPBELL, Royal Oak, MI (US)

(21) Appl. No.: 15/843,266

(22) Filed: Dec. 15, 2017

Related U.S. Application Data
(60) Provisional application No. 62/434,815, filed on Dec. 15, 2016.

(51) Int. Cl. F16D 25/12; F16D 48/06; F16D 28/00; F15B 7/08; F15B 15/28; B60K 23/02; F16H 37/04

(52) U.S. Cl. CPC F16D 25/12; F16D 48/06; F16D 28/00; F16H 1/06; F15B 15/2861; B60K 23/02; F16H 37/04; F15B 7/08

(57) ABSTRACT

An electronic clutch actuator for actuation of a clutch in a transmission of a vehicle includes a clutch master cylinder having a fluid cavity therein and adapted to be in fluid communication with a clutch slave cylinder coupled to the clutch of the transmission, a movable piston disposed in the fluid cavity of the clutch master cylinder, a rotatable screw having one end coupled to the piston to translate the piston, a geartrain disposed perpendicular to the rotatable screw to rotate the rotatable screw, and a motor having an output shaft disposed perpendicular to the geartrain to form a U-shaped arrangement to rotate gears of the geartrain.

### CROSS-REFERENCE TO RELATED APPLICATION(S)

The present application claims priority to and all the benefits of U.S. Provisional Patent Application No. 62/434,815, filed on Dec. 15, 2016, which is hereby expressly incorporated herein by reference in its entirety.

### BACKGROUND OF INVENTION

### 1. Field of Invention

The present invention relates generally to clutches for transmissions and, more specifically, to an electronic clutch actuator for actuation of a clutch in a transmission.

### 2. Description of the Related Art

Conventional vehicles typically include an engine having a rotational output that provides a rotational input into a transmission such as a manual transmission for a powertrain system of the vehicle. The transmission changes a rotational speed and torque generated by the output of the engine through a series of predetermined gearsets in a gearbox to transmit power to one or more wheels of the vehicle, whereby changing between the gearsets enables the vehicle to travel at different vehicle speeds for a given engine speed.

When a vehicle operator or driver wants to change from one gear to another, the driver presses down on a clutch footpedal of the vehicle. This operates a single clutch via a linkage, which disconnects the output of the engine from the input into the gearbox and interrupts power flow to the transmission. Then the vehicle operator uses a shift lever to select a new gear, a process that typically involves moving a toothed collar from one gear to another gear of a different size. In the gearbox, synchronizers match the gears before they are engaged to prevent grinding. Once the new gear is engaged, the driver releases the clutch footpedal, which re-connects the output of the engine to the input of the gearbox to transmit power to the wheels.

For the above-described transmission, original equipment manufacturers are developing enhanced clutch systems for manual transmissions to continually reduce carbon dioxide output and meet fuel saving requirements, which can provide new cost effective functionalities like automated free rolling operation (sailing) when the driver does not require engine torque. For example, an enhanced clutch system includes an electronic clutch actuator driven from vehicle controls to engage and disengage the clutch. However, the enhanced clutch system must function conventionally, and controls the clutch independently of the driver's actions as well for shifting gears in transmissions. Thus, there is a need in the art to provide an electronic clutch actuator for actuation of a clutch in a transmission.

### SUMMARY OF THE INVENTION

The present invention provides an electronic clutch actuator for actuation of a clutch in a transmission of a vehicle including a clutch master cylinder having a fluid cavity therein and adapted to be in fluid communication with a clutch slave cylinder coupled to the clutch of the transmission, a movable piston disposed in the fluid cavity of the clutch master cylinder, a rotatable screw having one end coupled to the piston to translate the piston, a geartrain disposed perpendicular to the rotatable screw to rotate the rotatable screw, and a motor having an output shaft disposed perpendicular to the geartrain to form a U-shaped arrangement to rotate gears of the geartrain.

One advantage of the present invention is that an electronic clutch actuator is provided for actuation of a clutch in a transmission having a U-shaped arrangement. Another advantage of the present invention is that the electronic clutch actuator uses a U-shape arrangement of system components along with a motor sensor and piston sensor on one board. Yet another advantage of the present invention is that the electronic clutch actuator driven from vehicle controls. Still another advantage of the present invention is that the electronic clutch actuator implements a separate component adapted to manual transmissions. A further advantage of the present invention is that the electronic clutch actuator is an “add-on” to the clutch system without any change in a vehicle driver's actions.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a diagrammatic view of one embodiment of a system, according to the present invention for actuation of a clutch in a transmission with an electronic clutch actuator, according to the present invention.

FIG. 2 is a diagrammatic view of the system of FIG. 1 illustrating the clutch engaged.

FIG. 3 is a diagrammatic view of the system of FIG. 1 illustrating the clutch disengaged.

FIG. 4 is a diagrammatic view of the system of FIG. 1 illustrating a clutch by wire connection.

FIG. 5 is a diagrammatic view of the system of FIG. 1 illustrating a clutch by fluid connection

FIG. 6 is a sectional view of one embodiment of the electronic clutch actuator, according to the present invention, used in the system of FIGS. 1-5.

### DETAILED DESCRIPTION OF THE INVENTION

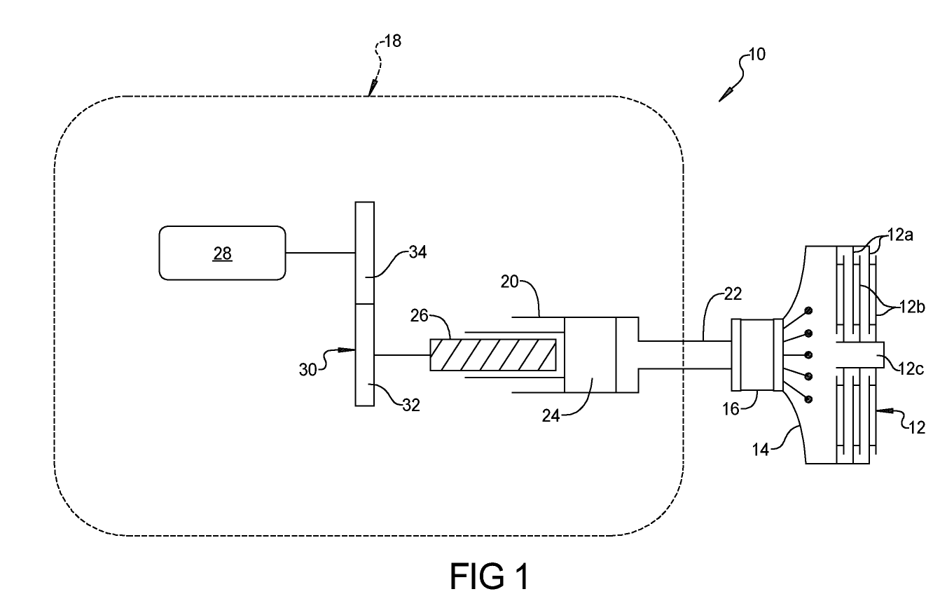

Referring now to the figures, where like numerals are used to designate like structure unless otherwise indicated, a system 10, according to the present invention, for actuation of a clutch, generally indicated at 12, in FIG. 1 for a transmission (not shown) of a vehicle (not shown). The vehicle includes an engine (not shown) and the transmission. In one embodiment, the engine is a conventional internal combustion engine known in the art. In one embodiment, the transmission is a manual transmission (MT). The engine has a rotatable output that is an engine input into the transmission. The transmission translates the engine input to a rotational output to transmit power to one or more wheels (not shown) of the vehicle. It should be appreciated that the clutch 12 is typically disposed between the engine input and an input shaft of a gearbox (not shown) of the transmission. It should also be appreciated that the system 10 forms an enhanced clutch system for the transmission. It should further be appreciated that the engine and/or transmission could be of any suitable type to drive the vehicle, without departing from the scope of the present invention.

As illustrated in FIG. 1, the clutch 12 is of a clutch pack type. In one embodiment, the clutch 12 includes a plurality of clutch plates 12a and a plurality of clutch disc 12b interleaved between and cooperating with the clutch plates 12a. The clutch discs 12b are coupled to a rotatable input shaft 12c of the gearbox. The clutch 12 includes a diaphragm spring 14 coupled to the clutch plates 12a to engage and disengage the clutch plates 12a with the clutch discs 12b. The clutch 12 also includes a clutch slave cylinder 16 coupled to the diaphragm spring 14 to actuate the diaphragm spring 14 to cause engagement and disengagement of the clutch plates 12a with the clutch discs 12b. It should be appreciated that the clutch slave cylinder 16 is a fluid cylinder having a movable piston coupled to the diaphragm spring 14. It should also be appreciated that the clutch 12 is conventional and known in the art.

The system 10 also includes an electronic clutch actuator, according to the present invention and generally indicated at 18, for actuating the clutch 12. In one embodiment, the electronic clutch actuator 18 includes a clutch master cylinder 20 fluidly connected by a conduit 22 to the clutch slave cylinder 16. The electronic clutch actuator 18 also includes a movable piston 24 disposed in the clutch master cylinder 20. It should be appreciated that movement of the piston 24 causes movement of fluid to actuate the clutch slave cylinder 16.

The electronic clutch actuator 18 includes a rotatable screw 26 coupled to the piston 24 to move or translate the piston 24. The rotatable screw 26 may cooperate with the piston 24 such that, when the rotatable screw 26 is rotated, this rotational movement causes translational movement of the piston 24. The electronic clutch actuator 18 includes a motor 28 for rotating the rotatable screw 26. The motor 28 is of a brushless direct current (BLDC) reversible or two directional output type and connected to a source of power. The electronic clutch actuator 18 further includes a geartrain, generally indicated at 30, between the motor 28 and the rotatable screw 26. In one embodiment, the geartrain 30 includes a first gear 32 coupled to the rotatable screw 26 and a second gear 34 coupled to the motor 28 for a predetermined gear ratio. It should be appreciated that the first gear 32 and second gear 34 meshingly engage each other to reduce the rotational output of the motor 28 to the rotatable screw 26.

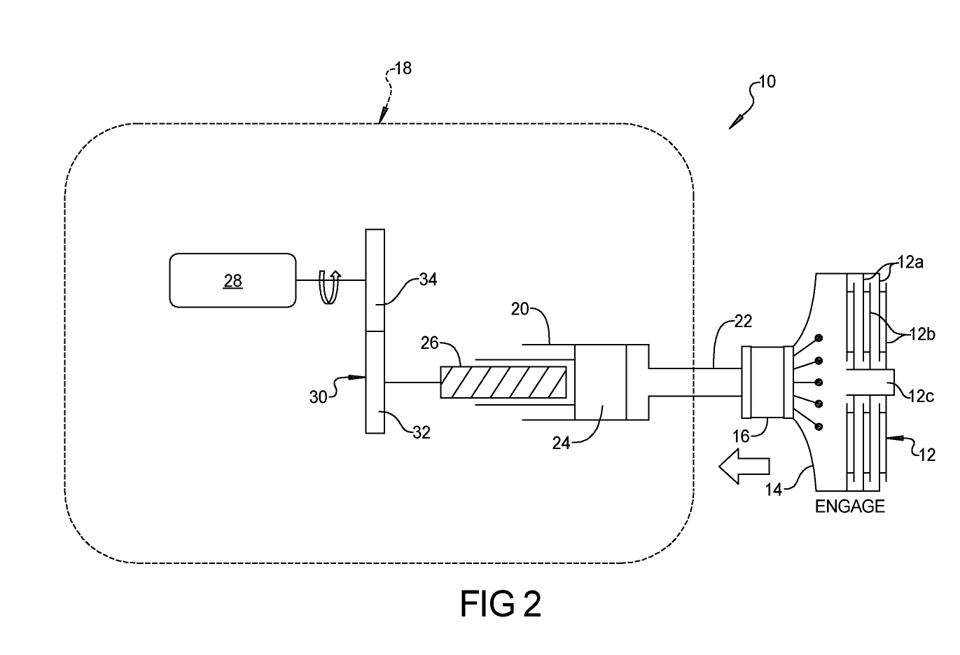

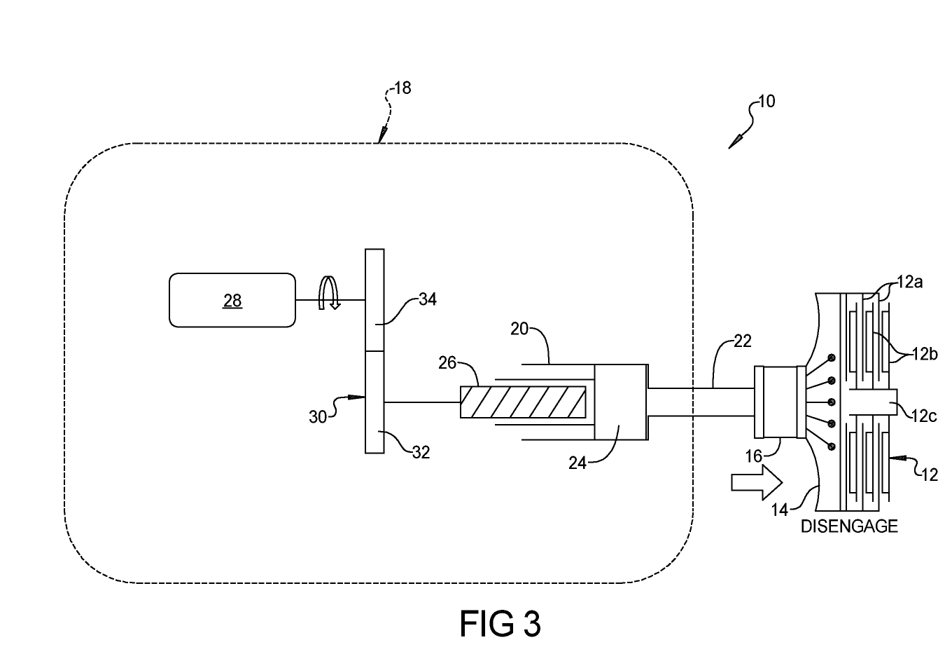

Referring to FIGS. 2 and 3, the system 10 is illustrated with the clutch 12 in an engaged position and disengaged position, respectively. As illustrated in FIG. 2, the motor 28 rotates its output shaft in a first direction to cause the gears 32 and 34 of the geartrain 30 and the rotational screw 26 to rotate. Rotation of the rotational screw 26 translates the movable piston 24 away from the end of the clutch master cylinder 20 and the clutch slave cylinder 16 and causes the diaphragm spring 14 to move such that the clutch plates 12a engage the clutch discs 12b. When this occurs, the output of the engine is connected to the input shaft 12c and the input shaft 12c rotates. As illustrated in FIG. 3, the motor 28 rotates its output shaft in a second direction opposite the first direction to cause the gears 32 and 34 of the geartrain 30 and the rotational screw 26 to rotate. Rotation of the rotational screw 26 translates the movable piston 24 toward the end of the clutch master cylinder 20 to move fluid to the clutch slave cylinder 16, which causes the diaphragm spring 14 to move such that the clutch plates 12a disengage the clutch discs 12b. When this occurs, the output of the engine is disconnected to the input shaft 12c and the input shaft 12c does not rotate.

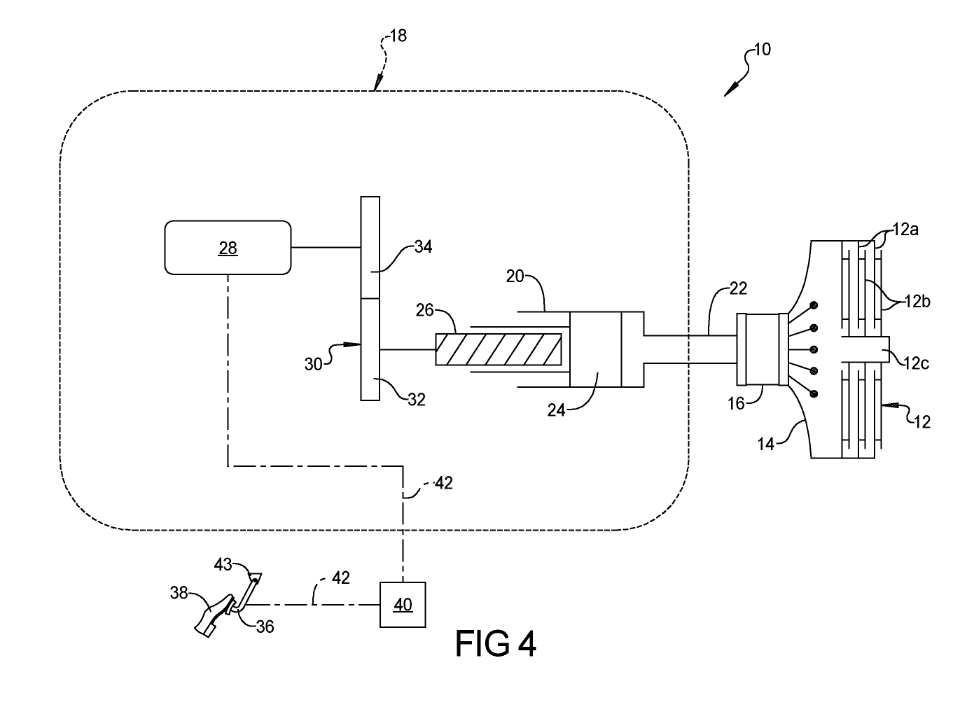

Referring to FIG. 4, the system 10 may actuate the clutch 12, in one embodiment, by a clutch by wire connection. In this embodiment, the system 10 includes a movable clutch footpedal 36 operated by a foot 38 of a vehicle operator (not shown) and a computer or electronic control module (ECM) 40 in communication with the clutch footpedal 36 and the motor 38 by a suitable mechanism such as one or more wires 42. The system 10 may include a clutch footpedal sensor 43 positioned near or coupled to the clutch footpedal 36 and in communication with the ECM 40 to sense a position of the clutch footpedal 36. It should be appreciated that, when the vehicle operator uses their foot 38 to move the clutch footpedal 36, the ECM 40 sends a corresponding signal to the motor 28 to cause the motor 28 to rotate its output shaft in either the first or second direction to actuate the clutch 12. It should also be appreciated that the clutch footpedal 36 and clutch footpedal sensor 43 are conventional and known in the art. It should further be appreciated that the ECM 40 may communicate with the clutch footpedal sensor 43 or other sensors s via a bus, hard wires, or a combination thereof. It should still further be appreciated that the ECM 40 is programmed to rotate the output of the motor 28 based on vehicle controls such as a signal from the clutch footpedal sensor 43 and one or more other sensors (not shown).

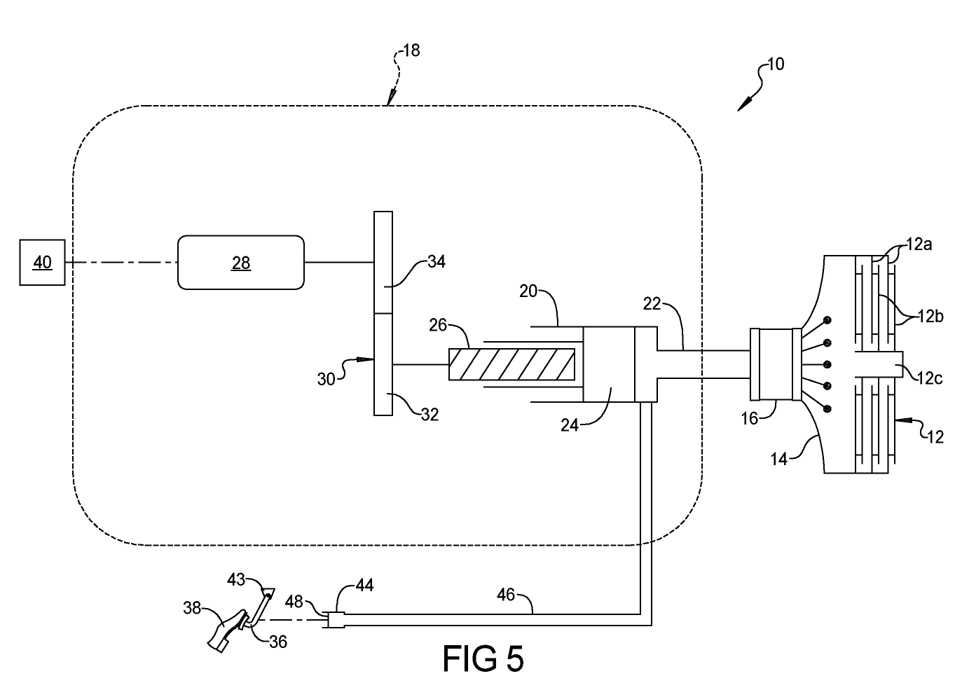

Referring to FIG. 5, the system 10 may actuate the clutch 12, in one embodiment, by a clutch by fluid connection. In this embodiment, the system 10 includes the movable footpedal 36 operated by the foot 38 of the vehicle operator or driver (not shown) and a footpedal master cylinder 44 fluidly connected by a conduit 46 to the clutch master cylinder 20 having a movable piston 48 coupled to the clutch footpedal 36 and disposed in the footpedal master cylinder 44. It should be appreciated that, when the vehicle operator uses their foot 38 to move the clutch footpedal 36, the piston 48 causes movement of fluid to actuate the clutch slave cylinder 16.

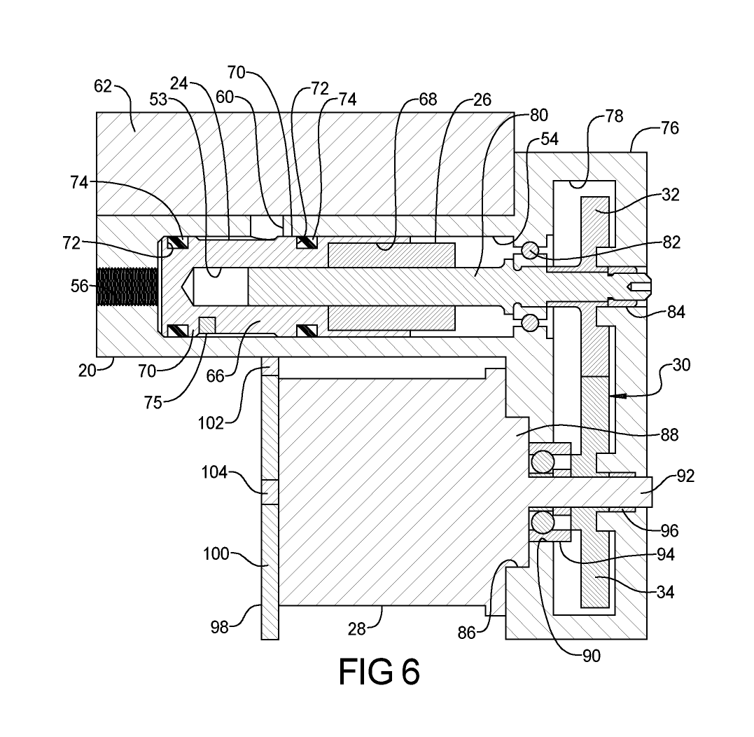

Referring to FIG. 6, one embodiment of the electronic clutch actuator 18 is shown. In one embodiment, the clutch master cylinder 20 is generally cylindrical in shape and extends axially. The clutch master cylinder 20 has a passageway 53 and a cavity 54 extending axially therein. The cavity 54 has a generally circular cross-section. The clutch master cylinder 20 includes a first or output port 56 extending through one end for fluid communication between the cavity 54 and the clutch slave cylinder 16 to move the movable piston 24. The clutch master cylinder 20 also includes a second or inlet port (not shown in this figure) extending through one side thereof for fluid communication between the cavity 54 and the fluid conduit 46. The clutch master cylinder 20 further includes a third or reservoir port 60 extending through another side thereof for fluid communication between the cavity 54 and a fluid reservoir 62. The electronic clutch actuator 18 may include a check valve (not shown in this figure) disposed in fluid communication between the third port 60 and the fluid reservoir 62 to allow one way fluid flow from the third port 60 to the fluid reservoir 62.

As illustrated in FIG. 6, in one embodiment, the piston 24 is generally cylindrical in shape and extends axially. The piston 24 includes a shaft 66 extending axially. The shaft 66 is generally cylindrical in shape with a generally circular cross-section. The shaft 66 has a cavity 68 extending axially into one end thereof to receive an end of the rotatable screw 26. The piston 24 includes one or more lands 70 extending radially from and spaced axially along the shaft 66. In the embodiment illustrated, one land 70 is disposed axially at the end of the shaft 66 opposite the cavity 68 and another land 70 is disposed axially between the land 70 and the cavity 68. The lands 70 are generally cylindrical in shape with a generally circular cross-section. Each of the lands 70 have a groove 72 extending circumferentially therealong and radially therein. The piston 24 further includes a seal 74 disposed in the groove 72 of each of the lands 70. The seal 74 is annular and made of a flexible material to engage a wall of the clutch master cylinder 20 to prevent fluid flow past the land 70. The piston 24 may include a magnet 75 disposed between the lands 70. It should be appreciated that the piston 24 allows fluid to be routed to the clutch slave cylinder 16 or the fluid reservoir 62. It should also be appreciated that the piston 24 may be a fluid switch valve.

The electronic clutch actuator 18 also includes a gear housing 76 disposed perpendicular to the clutch master cylinder 20 to form a general “L” shape. The gear housing 76 may be a separate housing or integral with the clutch master cylinder 20. The gear housing 76 includes a cavity 78 to house the geartrain 30. The geartrain 30 includes a rotatable shaft 80 extending axially through the rotatable screw 26 and into the passageway 53 of the piston 24 and through the cavity 78 of the gear housing 76. The shaft 80 is rotatably supported in the gear housing 76 by a bearing 82. The bearing 82 may be of a roller ball type with races formed by the gear housing 76. The first gear 32 is disposed in the cavity 78 and about the shaft 80. It should be appreciated that a bushing 84 may be disposed in the gear housing 76 to support the end of the shaft 80.

The gear housing 76 also includes an outer recess 86 to receive an axially extending portion 88 of the motor 28. The gear housing 76 includes an aperture 90 extending axially from the recess 86 and communicating with the cavity 78 to receive an output shaft 92 of the motor 28. The output shaft 92 may be rotatably supported in the gear housing 76 by a bearing 82 or a torsion spring brake 94 to prevent back driving of the output shaft 92 of the motor 28. The second gear 34 is disposed in the cavity 78 and about the output shaft 92. It should be appreciated that a bushing 96 may be disposed in the gear housing 76 to support the end of the output shaft 92. It should also be appreciated that the torsion spring brake 94 is optional. It should further be appreciated that the piston 24, geartrain 30, and motor 28 form a general “U” shape arrangement.

The electronic clutch actuator 18 includes an electronic control unit 98 disposed adjacent the motor 28 and the piston 24. The electronic control unit 98 includes a circuit board 100 disposed at a back or rear end of the motor 28 opposite the output shaft 92. The circuit board 100 is generally planar and orientated perpendicular to the piston 24. The electronic control unit 100 includes a piston sensor 102 disposed at one end of the circuit board 100 to sense the linear position of the magnet 75 on the piston 24. The electronic control unit 100 further includes a motor sensor 104 spaced radially from the piston sensor 102 to sense the rotational position of the output shaft 92 of the motor 28. The piston sensor 102 and the motor sensor 104 are of a Hall-effect or variable reluctance type. It should be appreciated that the motor sensor 104 and the piston sensor 102 are arranged on one electronic control unit 98. It should also be appreciated that the electronic control unit 98 and ECM 40 may be separate or one in the same. It should further be appreciated that the electronic clutch actuator 18 is for automated manual clutch transmissions.

Accordingly, the system 10 of the present invention is provided as an enhanced clutch system for actuation of the clutch 12 having the electronic clutch actuator 18 for a transmission of a vehicle. The system 10 of the present invention allows both a vehicle driver and the system 10 to control the clutch 12 seamlessly for shifting. The system 10 of the present invention is an “add-on” to the clutch 12 without any change in a vehicle driver's actions.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

What is claimed is:

1. An electronic clutch actuator for actuation of a clutch in a transmission of a vehicle, said electronic clutch actuator comprising:
a clutch master cylinder having a fluid cavity extending axially therein and adapted to be in fluid communication with a clutch slave cylinder coupled to the clutch of the transmission;
a movable piston disposed in said fluid cavity of said clutch master cylinder;
a rotatable screw having one end coupled to said piston to translate said piston;
a geartrain disposed perpendicular to said rotatable screw to rotate said rotatable screw; and
a motor having an output shaft disposed perpendicular to said geartrain to form a U-shaped arrangement to rotate gears of said geartrain.

2. An electronic clutch actuator as set forth in claim 1 including a magnet coupled to said piston.

3. An electronic clutch actuator as set forth in claim 2 including an electronic control unit disposed at one end of said motor opposite said output shaft.

4. An electronic clutch actuator as set forth in claim 3 wherein said electronic control unit includes a circuit board oriented perpendicular to said piston.

5. An electronic clutch actuator as set forth in claim 4 wherein said electronic control unit includes a piston sensor at one end of said circuit board to sense a linear position of said magnet.

6. An electronic clutch actuator as set forth in claim 5 wherein said electronic control unit includes motor sensor disposed on said circuit board radially from said piston sensor to sense a rotational position of said output shaft.

7. An electronic clutch actuator as set forth in claim 1 wherein said piston includes a shaft extending axially and a plurality of lands extending radially from and spaced axially along said shaft, said magnet being disposed between said lands.

8. An electronic clutch actuator as set forth in claim 1 including a gear housing disposed perpendicular to said clutch master cylinder and having a cavity therein.

9. An electronic clutch actuator as set forth in claim 8 wherein said geartrain comprises a first gear disposed in said cavity of said gear housing and coupled to said rotatable screw.

10. An electronic clutch actuator as set forth in claim 9 wherein said geartrain comprises a second gear disposed in said cavity of said gear housing and coupled to said output shaft of said motor and meshingly engaging said first gear.

11. An electronic clutch actuator as set forth in claim 8 wherein said electronic clutch actuator further comprises a torsion spring brake coupled to said output shaft of said motor and said gear housing to prevent back drive of said output shaft.

12. An electronic clutch actuator for actuation of a clutch in a transmission of a vehicle, said system comprising:
a clutch master cylinder having a fluid cavity extending axially therein and adapted to be in fluid communication with a clutch slave cylinder coupled to the clutch of the transmission and a clutch footpedal of the vehicle;
said clutch master cylinder having a first port fluidly communicating with said fluid cavity and adapted for fluid communication with the clutch slave cylinder, a second port fluidly communicating with said fluid cavity and adapted for fluid communication with the clutch footpedal, and a third port fluidly communicating with said fluid cavity and adapted for fluid communication with a fluid reservoir;
a movable piston disposed in said fluid cavity of said clutch master cylinder;
a rotatable screw having one end coupled to said piston to translate said piston;
a geartrain disposed perpendicular to said rotatable screw to rotate said rotatable screw; and
a motor having an output shaft disposed perpendicular to said geartrain to form a U-shaped arrangement to rotate gears of said geartrain.

13. An electronic clutch actuator as set forth in claim 12 including a magnet coupled to said piston.

14. An electronic clutch actuator as set forth in claim 13 including an electronic control unit disposed at one end of said motor opposite said output shaft.

15. An electronic clutch actuator as set forth in claim 14 wherein said electronic control unit includes a circuit board oriented perpendicular to said piston.

16. An electronic clutch actuator as set forth in claim 15 wherein said electronic control unit includes a piston sensor at one end of said circuit board to sense a linear position of said magnet.

17. An electronic clutch actuator as set forth in claim 16 wherein said electronic control unit includes a motor sensor disposed on said circuit board radially from said piston sensor to sense a rotational position of said output shaft.

18. An electronic clutch actuator as set forth in claim 15 including a gear housing disposed perpendicular to said clutch master cylinder and having a cavity therein.

19. An electronic clutch actuator as set forth in claim 18 wherein said geartrain comprises a first gear disposed in said cavity of said gear housing and coupled to said rotatable screw and a second gear disposed in said cavity of said gear housing and coupled to said output shaft of said motor and meshingly engaging said first gear.

20. An electronic clutch actuator for actuation of a clutch in a transmission of a vehicle, said system comprising:
a clutch master cylinder having a fluid cavity extending axially therein and adapted to be in fluid communication with a clutch slave cylinder coupled to the clutch of the transmission and a clutch footpedal of the vehicle;
said clutch master cylinder having a first port fluidly communicating with said fluid cavity and adapted for fluid communication with the clutch slave cylinder, a second port fluidly communicating with said fluid cavity and adapted for fluid communication with the clutch footpedal, and a third port fluidly communicating with said fluid cavity and adapted for fluid communication with a fluid reservoir;
a movable piston disposed in said fluid cavity of said clutch master cylinder;
a magnet coupled to said piston;
a rotatable screw having one end coupled to said piston to translate said piston;
a geartrain disposed perpendicular to said rotatable screw to rotate said rotatable screw;
a motor having an output shaft disposed perpendicular to said geartrain to form a U-shaped arrangement to rotate gears of said geartrain; and
an electronic control unit disposed at one end of said motor opposite said output shaft, said electronic control unit comprising a circuit board oriented perpendicular to said piston, a piston sensor at one end of said circuit board to sense a linear position of said magnet, and a motor sensor disposed on said circuit board radially from said piston sensor to sense a rotational position of said output shaft.
